(19) United States
(12) Patent Application Publication
(10) Pub. No.: US 2014/0331749 A1
(43) Pub. Date: Nov. 13, 2014

(54) Pet Training Pad with Diagnostic Material to Detect Wetness

(71) Applicant: Robert PERISSI, Simsbury, CT (US)

(72) Inventor: Robert PERISSI, Simsbury, CT (US)

(73) Assignee: MEDNET DIRECT CORP, Farmington, CT (US)

(21) Appl. No.: 14/274,585

(22) Filed: May 9, 2014

Related U.S. Application Data
(60) Provisional application No. 61/821,429, filed on May 9, 2013.

(51) Int. Cl. G01N 33/00

(52) U.S. Cl. CPC G01N 33/00
USPC 73/73

(57) ABSTRACT

A pet training pad with diagnostic materials to detect wetness includes an impermeable bottom layer, at least one absorbent layer, a wetness indicator, and a permeable top layer. The at least one absorbent layer is connected on to the impermeable bottom layer, and the wetness indicator is positioned on the at least one absorbent layer. The permeable top layer is positioned on the at least one absorbent layer and perimetrically connected to the impermeable bottom layer enclosing the at least one absorbent layer. When any kind of bodily fluid penetrates through the permeable top layer, the wetness indicator detects the bodily fluid within the training pad and is able to visually indicate the wetness of the training pad to pet owners or caregivers.

The current application claims a priority to the U.S. Provisional Patent application Ser. No. 61/821,429 filed on May 9, 2013.

### FIELD OF THE INVENTION

The present invention relates generally to a training pad for use in animal training and includes a wetness indicator, where the wetness indicator visibly provides information regarding the medical condition and bodily fluid of the animal to an owner or a caregiver.

### BACKGROUND OF THE INVENTION

Training pads are commonly used by pet owners to house train animals. Such training pads typically include a layer of waterproof material on the bottom, an absorbent layer of material that is typically placed above the waterproof material, and a top portion of the training pad that is typically made of a soft material for comfort. The training pads are capable of absorbing any kind of bodily fluids from a pet, where the absorbed bodily fluids are trapped within the training pads, preventing any kind of leakage. Often time, the owners or the caregivers of the pet are unable to visually identify that the training pad is used by the pet. As a result, the house training of the pet can be delayed since the pet might not prefer to use the wet training pad. Additionally, the owners or the caregivers either have to touch or smell the training pads in order to confirm that the training pads are being used.

It is an object of the present invention to provide a training pad that includes a wetness indicator, such that the wetness indicator is able to visually notify the pet owner or the caregiver that the training pad is wet and has been used. Additionally, the wetness indicator is positioned within the present invention with a common predefined pattern so that the pet owner or the caregiver is easily able to recognize the wet training pad. It is also possible for the present invention to be adapted for human use in various alternative embodiments.

### BRIEF DESCRIPTION OF THE DRAWINGS

FIG. 1 is a perspective view of the present invention.

FIG. 2 is an exploded view of the present invention.

FIG. 3 is a top view of the present invention, wherein no bodily fluid is penetrated into the present invention.

FIG. 4 is a top view of the present invention showing the wetness indicator, wherein bodily fluid is absorbed by the at least one absorbent layer.

### DETAIL DESCRIPTIONS OF THE INVENTION

All illustrations of the drawings are for the purpose of describing selected versions of the present invention and are not intended to limit the scope of the present invention.

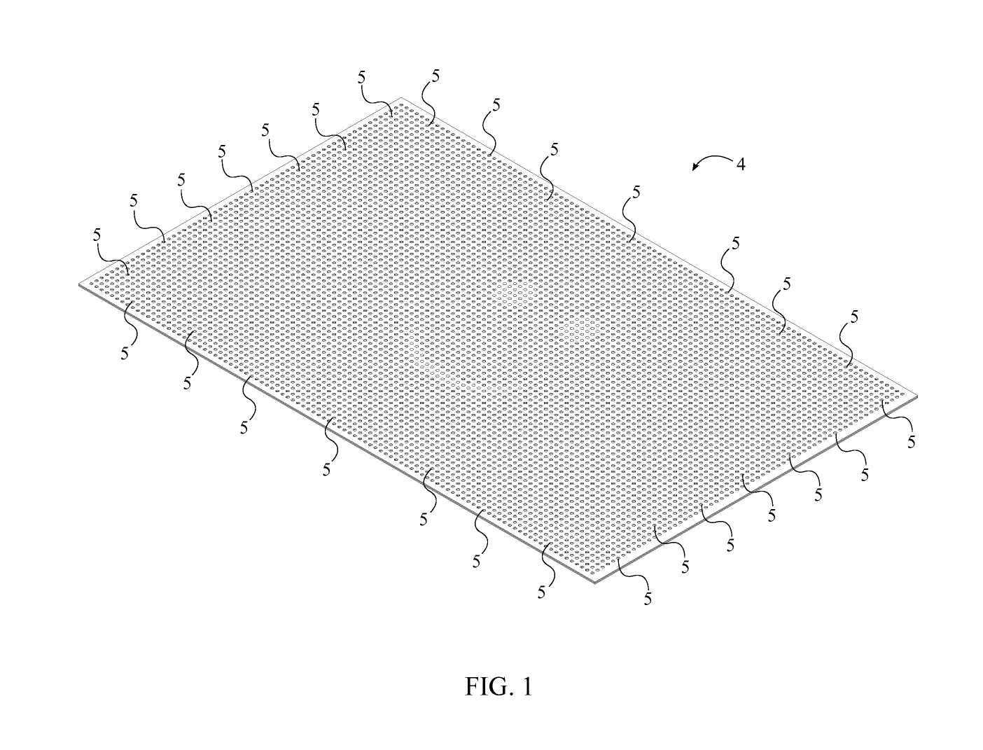

In reference to FIG. 1, the present invention is a pet training pad with diagnostic materials to detect the wetness, as the wetness can be created by any kind of bodily fluid including, but not limited to blood, urine, and mucous. The present invention comprises an impermeable bottom layer 1, at least one absorbent layer 2, a wetness indicator 3, and a permeable top layer 4. While the present invention is intended for use by animals in the preferred embodiment, it is to be known that in various alternative embodiments the present invention can be adapted for human use.

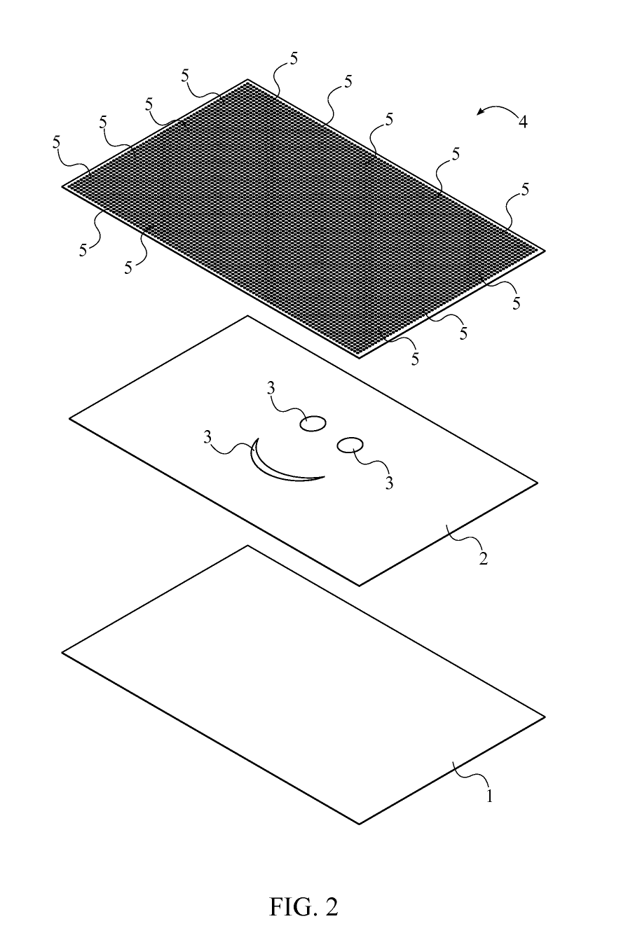

In reference to FIG. 2, the impermeable bottom layer 1 is made from water proof materials, where the impermeable bottom layer 1 functions as the last barrier against any kind of bodily fluids. The impermeable bottom layer 1 completely eliminates any kind of leakage from the bottom of the present invention so that a resting surface of the present invention does not get contaminated with any kind of bodily fluid. The at least one absorbent layer 2 is connected on to the impermeable bottom layer 1. The at least one absorbent layer 2 is preferably made of an absorbent material, which may be a cellulose based pulp, a super absorbent polymer, or any other related material. The at least one absorbent layer 2 is able to absorb a large amount of bodily fluid, where the at least one absorbent layer 2 has a quick absorption time. The at least one absorbent layer 2 is also able to contain any foul odor within the present invention so that the present invention is able to create a pleasant surrounding environment around the resting surface.

The wetness indicator 3 is adjacently positioned with the at least one absorbent layer 2. Depending on different embodiments of the present invention, the exact positioning of the wetness indicator 3 can vary. More specifically, the wetness indicator 3 for a first embodiment of the present invention is connected on the at least one absorbent layer 2, where the wetness indicator 3 is connected to the at least one absorbent layer 2 by using any kind of suitable adhesive. The wetness indicator 3 for a second embodiment of the present invention is integrated into the at least one absorbent layer 2, where the second embodiment does not use any kind of adhesive since the wetness indicator 2 is manufactured into the absorbent layer 2.

In reference to FIG. 1 and FIG. 2, the permeable top layer 4 is positioned on the at least one absorbent layer 2 and perimetrically connected around the impermeable bottom layer 1. More specifically, the at least one absorbent layer 2 is enclosed by the permeable top layer 4 and the impermeable bottom layer 1. The permeable top layer 4 comprises a plurality of holes 5, where the plurality of holes 5 is traversed through the permeable top layer 4. The permeable top layer 4 is preferably a nonwoven material so that the bodily fluid can be easily penetrated into the at least one absorbent layer 2 through the plurality of holes 5.

The wetness indicator 3 is preferably arranged and positioned in such a way that the wetness indicator 3 forms a desired sign or other design 6 that can be easily identified by the users of the present invention. For example, the wetness indicator 3 can include, but is not limited to, a smiley face, a frowning face, a plus sign, a minus sign, the word “yes”, and the word “no”. The wetness indicator 3 clearly notifies the pet owners or the caregivers that the present invention has already been used by the pet. The wetness indicator 3 functions similar to strip test material that is commonly used to test for certain medical conditions. Typically, these strip tests change color when exposed to the test taker's urine to indicate a particular medical condition or perhaps the lack thereof. These tests include but are not limited to pregnancy tests, ovulation detection strips, menopause (FSH) tests, free radical test dipstreams, glucose in urine screening tests, nitrite in urine screening tests, protein in urine screening tests, skin growth monitoring tests, and visual blood glucose tests. In the preferred embodiment of the present invention, the wetness indicator 3 is calibrated for use with pets, and may be customized for specific species, breeds or even for specific pets, if necessary. The wetness indicator 3, however, may also be calibrated for human use as well, if desired. For example, the wetness indicator 3 can be calibrated to detect any pH level changes so that the wetness indicator 3 is able to change color upon contact of different bodily fluid and their pH levels, indicating the wetness of the present invention.

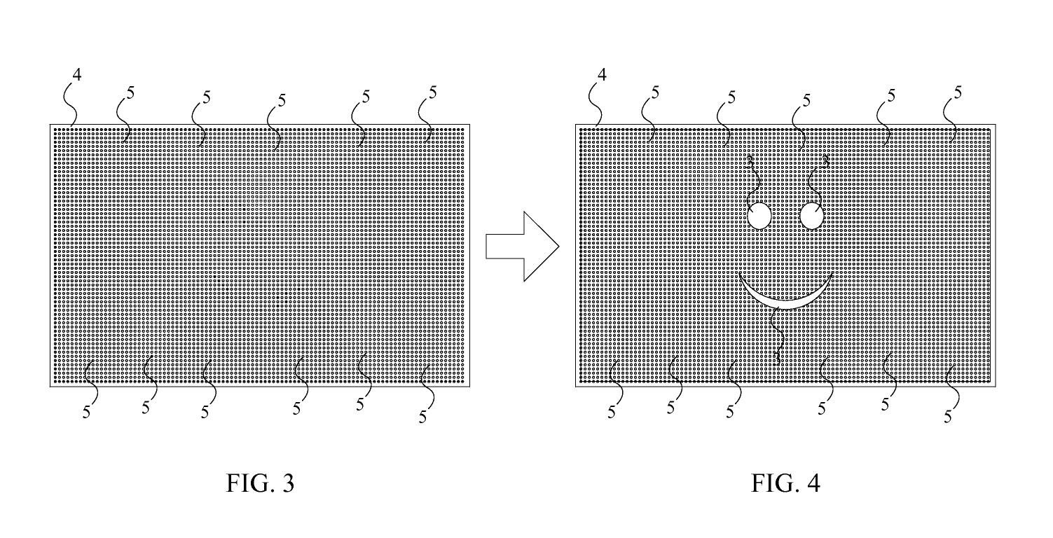

In reference to FIG. 3 and FIG. 4, once the bodily fluid is entered into the at least one absorbent layer 2 through the permeable top layer 4, the bodily fluid contacts with the wetness indicator 3 and changes the color within the present invention. More specifically, the color only changes within the wetness indicator 3 and visually displays the desired sign or other design 6 of the wetness indicator 3 through the plurality of holes 5. Then the pet owner or caregiver is easily able to identify the wetness of the present invention.

The present invention can be constructed in different sizes in order to accommodate for various amounts of bodily fluids. For example, larger size pet training pads are recommended for larger pets so that the present invention is able to absorb increased amounts of urine. However, smaller size pet training pads are recommended for smaller pets. The perimetrically connected at least one absorbent layer 2 and the impermeable bottom layer 1 provide a sealed-edge around the present invention so that the absorbed bodily fluid is completely contained within the present invention in order to protect the resting surface.

Although the invention has been explained in relation to its preferred embodiment, it is to be understood that many other possible modifications and variations can be made without departing from the spirit and scope of the invention as hereinafter claimed.

What is claimed is:

1. A pet training pad with diagnostic material to detect wetness comprises:
an impermeable bottom layer;
at least one absorbent layer;
a wetness indicator;
a permeable top layer;
the at least one absorbent layer being connected on the impermeable bottom layer;
the wetness indicator being adjacently positioned with the at least one absorbent layer;
the permeable top layer being positioned on the at least one absorbent layer; and
the permeable top layer being perimetrically connected around the impermeable bottom layer.

2. The pet training pad with diagnostic material to detect wetness as claimed in claim 1, wherein the at least one absorbent layer being enclosed by the permeable top layer and the impermeable bottom layer.

3. The pet training pad with diagnostic material to detect wetness as claimed in claim 1, wherein the wetness indicator being connected on the at least one absorbent layer.

4. The pet training pad with diagnostic material to detect wetness as claimed in claim 1, wherein the wetness indicator being integrated within the at least one absorbent layer.

5. The pet training pad with diagnostic material to detect wetness as claimed in claim 1 comprises,
the permeable top layer comprises a plurality of holes; and
the plurality of holes traversing through the permeable top layer, wherein the wetness indicator being visible through the plurality of holes upon contact of any bodily fluids.

6. A pet training pad with diagnostic material to detect wetness comprises:
an impermeable bottom layer;
at least one absorbent layer;
a wetness indicator;
a permeable top layer;
the at least one absorbent layer being connected on the impermeable bottom layer;
the wetness indicator being adjacently positioned with the at least one absorbent layer;
the permeable top layer being positioned on the at least one absorbent layer;
the permeable top layer being perimetrically connected around the impermeable bottom layer; and
the at least one absorbent layer being enclosed by the permeable top layer and the impermeable bottom layer.

7. The pet training pad with diagnostic material to detect wetness as claimed in claim 6, wherein the wetness indicator being connected on the at least one absorbent layer.

8. The pet training pad with diagnostic material to detect wetness as claimed in claim 6, wherein the wetness indicator being integrated within the at least one absorbent layer.

9. The pet training pad with diagnostic material to detect wetness as claimed in claim 6 comprises,
the permeable top layer comprises a plurality of holes; and
the plurality of holes traversing through the permeable top layer, wherein the wetness indicator being visible through the plurality of holes upon contact of any bodily fluids.

10. A pet training pad with diagnostic material to detect wetness comprises:
an impermeable bottom layer;
at least one absorbent layer;
a wetness indicator;
a permeable top layer;
the permeable top layer comprises a plurality of holes;
the at least one absorbent layer being connected on the impermeable bottom layer;
the wetness indicator being adjacently positioned with the at least one absorbent layer;
the permeable top layer being positioned on the at least one absorbent layer;
the permeable top layer being perimetrically connected around the impermeable bottom layer;
the at least one absorbent layer being enclosed by the permeable top layer and the impermeable bottom layer; and
the plurality of holes traversing through the permeable top layer, wherein the wetness indicator being visible through the plurality of holes upon contact of any bodily fluids.

11. The pet training pad with diagnostic material to detect wetness as claimed in claim 10, wherein the wetness indicator being connected on the at least one absorbent layer.

12. The pet training pad with diagnostic material to detect wetness as claimed in claim 10, wherein the wetness indicator being integrated within the at least one absorbent layer.

13. The pet training pad with diagnostic material to detect wetness as claimed in claim 1, wherein the wetness indicator being positioned as a design.

14. The pet training pad with diagnostic material to detect wetness as claimed in claim 10, wherein the wetness indicator being positioned as a design.
